(19) United States
(12) Patent Application Publication
(10) Pub. No.: US 2006/0268960 A1
(43) Pub. Date: Nov. 30, 2006

(54) Apparatus to frequency hop an orthogonal frequency division multiplexing access method using digital signal processing technique

(75) Inventors: Robert Townsend Short, Vista, CA (US); David Darryl Denton, San Jose, CA (US)

Correspondence Address: PATENTRY, P.O. BOX 151616, SAN RAFAEL, CA, 94915-1616, US

(73) Assignee: COMMSTACK, INC, San Jose, CA (US)

(21) Appl. No.: 10/908,905

(22) Filed: May 31, 2005

(51) Int. Cl. H04B 1/00

(52) U.S. Cl. 375/132

(57) ABSTRACT

Apparatus to frequency hop an orthogonal frequency division multiplexing access method using digital signal processing technique.

### BACKGROUND OF THE INVENTION

Typically frequency hopping in orthogonal frequency division multiplexing access systems is accomplished in the analog radio frequency stage. In a rapidly hopping system where the frequencies are not compatible, the use of multiple synthesized frequencies may be uneconomical and the mixing of frequencies may produce performance degradation. Particularly in the target market served by the multiband orthogonal frequency division multiplex alliance, such cost factors are prohibitively expensive.

Thus it can be appreciated that what is needed is a more economical method of using digital circuits to economically implement rapid frequency hopping in a multiband orthogonal frequency division multiplexing alliance compatible environment.

### SUMMARY OF THE INVENTION

The present invention shifts the frequency hopping apparatus into the digital stage both in transmission and in reception. A complex oversampled digital signal with limited resolution is down converted by a digital mixer which generates a dehopped digital baseband signal. A secondary input to the digital mixer is a digital LO sequence whose hopping sequence is designed to match the input signal hopping sequence. Band selection is effected by driving the digital LO signal as a series of either forward rotating, or reverse rotating or non-rotating complex local oscillator values to downconvert the digitized signal.

### DETAILED DESCRIPTION

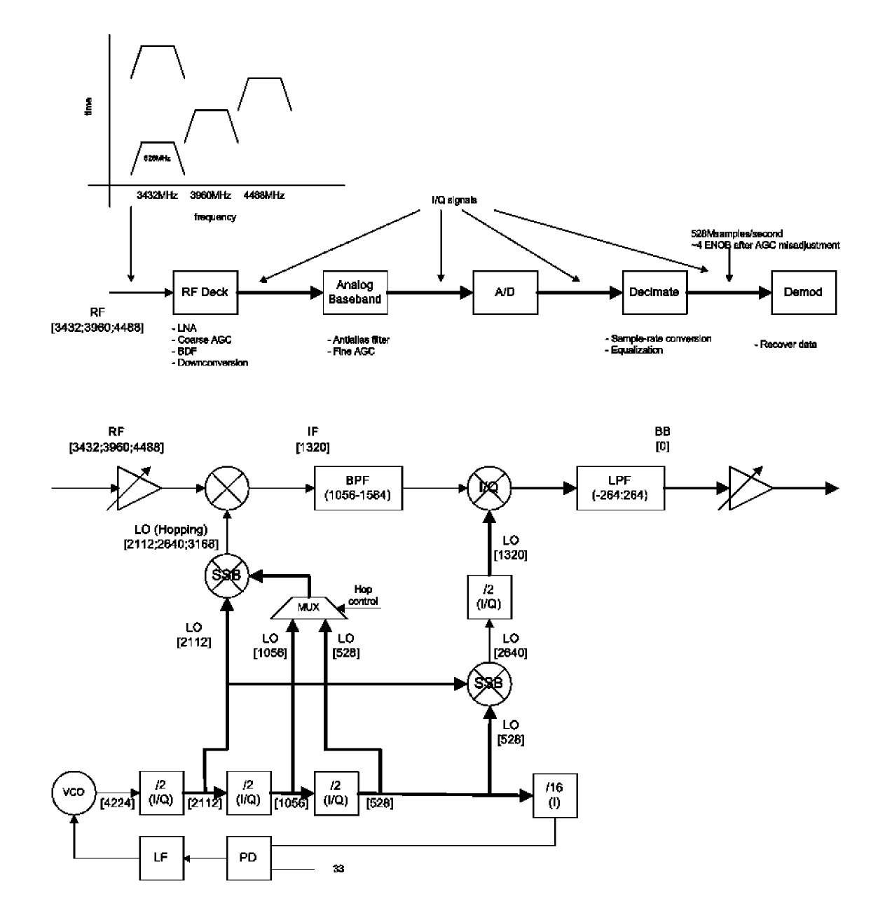

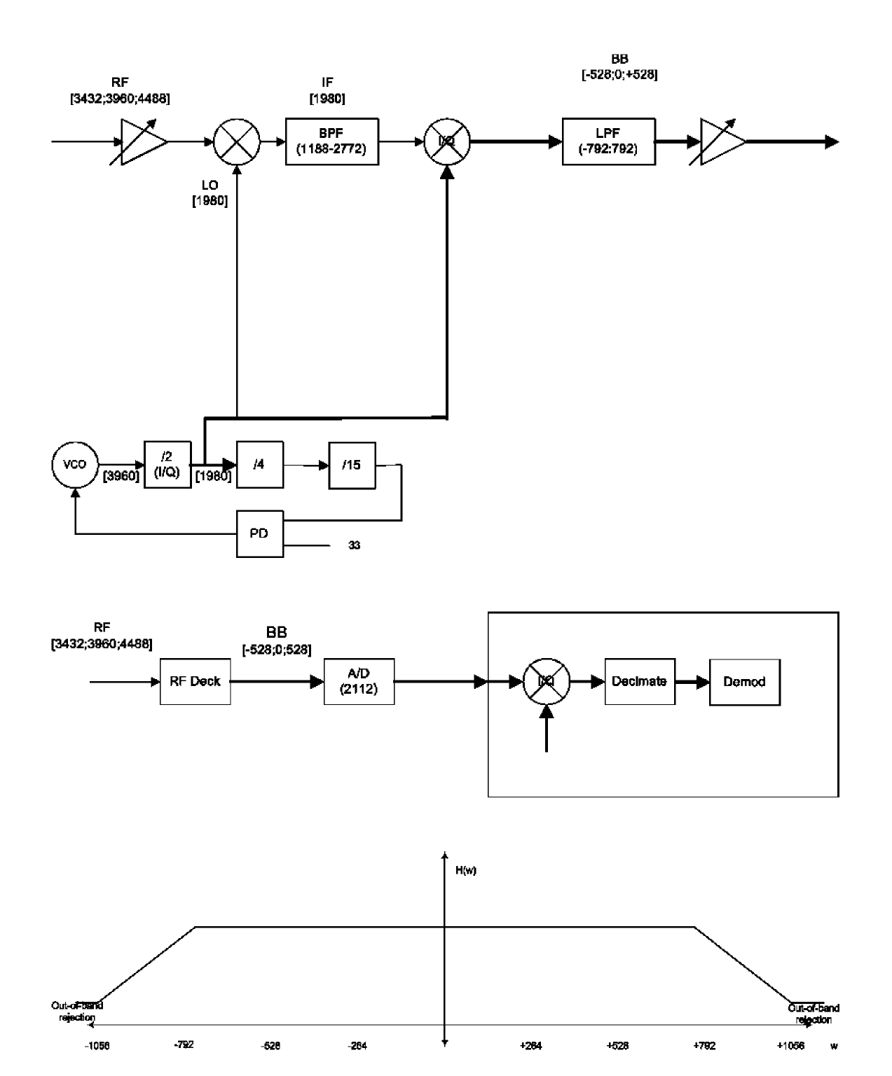

Referring now to FIG. 4, through conventional means, a frequency hopping signal in the radio frequency range is downconverted to an analog frequency hopping signal in the base band range through the RF deck 410. In an embodiment the signal hops in a known sequence between the center of the basebase and 528 MHz above the baseband and 528 MHz below the baseband. The RF deck is attached to an analog to digital converter 420, in an embodiment a 4× oversampled analog to digital converter sampling at 2112 M samples per second, which emits complex I and Q hopping digital baseband output. The analog to digital converter 420 is attached to a digital mixer 430 which generates the dehopped baseband signal. The digital mixer 430 is also driven by a digital local oscillator signal generator 430, in an embodiment a lookup table. In an embodiment the lookup table is driven by a counter and by a band selector whereby a sequence of complex values for I and Q are emitted. This sequence corresponds to the complex exponential sequence shown by
m(t)=exp (i2pi Fs/4 * fb *t).

The transmission method of frequency hopping in the digital mixer comprises the steps of

firstly, selecting an OFDM hopping pattern,

secondly, modulating each OFDM symbol into a complex baseband sequence,

thirdly, generating a hopping up conversion local oscillator signal as follows:

to shift the basebase signal to one of the selected bands according to the selected hopping pattern,

to shift the baseband up by one band multiply the baseband signal by exp(i2pi Fs/4* fb* t) where fb is positive one,

to leave the baseband signal unshifted multiply the baseband signal by exp(i2pi Fs/4* fb* t) where fb is zero, which is unity

to shift the baseband down by one band multiply the baseband signal by exp(i2pi Fs/4 *fb* t) where fb is negative one,

and where t counts up modulo 4 (0,1,2,3).

fourthly, mixing the baseband signal with the local oscillator signal to produce a hopping baseband signal, and

fifthly, converting the signal through a digital to analog converter, interpolating, and upconverting to an RF signal.

The reception method of frequency hopping in the digital mixer comprises the steps of

firstly, demodulating RF signals into a analog baseband sequence,

secondly, converting the hopping analog signal to hopping complex digital baseband signal using a 4× oversampling analog to digital converter with reduced resolution, in an embodiment, one less bit,

thirdly, generating a hopping down conversion local oscillator signal

to shift the selected band signal to the baseband according to the selected hopping pattern,

to shift the hopping signal up by one band multiply the hopping signal by exp (i2pi Fs/4 fb t) where fb is positive one,

to leave the hopping signal unshifted multiply the hopping signal by exp (i2pi Fs/4 fb t) where fb is zero, which is unity

to shift the hopping down by one band multiply the hopping signal by exp (i2pi Fs/4 fb t) where fb is negative one,

and where t counts up modulo 4 (0,1,2,3).

fourthly, mixing the hopping baseband signal with the hopping local oscillator signal to produce a baseband signal, and

fifthly, filtering and decimating the signal.

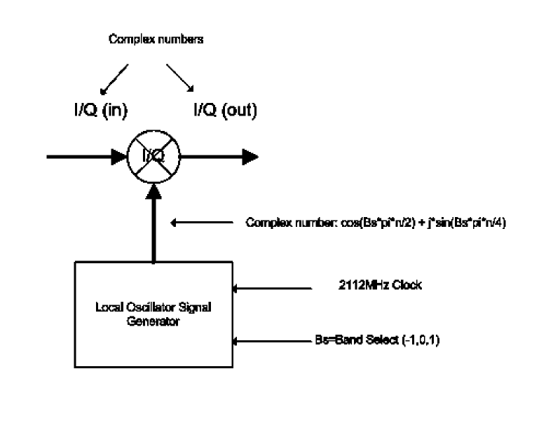

Referring now to FIG. 6, a complex digital signal may be up or down converted by applying a hopping digital local oscillator signal to a mixer. In an embodiment, a lookup table with the values (1,0), (0,1), (−1,0), and (0,−1) may be addressed with a 2 bit counter set to run continuously, and a band select input to emit forward rotating, backward rotating, or non-rotating values.

An apparatus to frequency hop an orthogonal frequency division multiplexing access method using digital signal processing technique comprising a 4× oversampled analog to digital converter with reduced resolution attached to a complex down conversion mixer controlled by a digital hopping local oscillator attached to an complex local oscillator signal generator attached to a counter and also attached to a band selector, the mixer then feeding a filter and decimator.

An apparatus to frequency hop an orthogonal frequency division multiplexing access method using digital signal processing technique comprising a 4× oversampled digital to analog converter with reduced resolution attached to a complex up conversion mixer controlled by a digital hopping local oscillator attached to an complex local oscillator signal generator attached to a counter and also attached to a band selector, the mixer then feeding an interpolator.

What is claimed is:

1. An apparatus to frequency hop an orthogonal frequency division multiplexing access method using digital signal processing technique comprising a 4× oversampled analog to digital converter with reduced resolution attached to a complex down conversion mixer controlled by a digital hopping local oscillator attached to an complex local oscillator signal generator attached to a counter and also attached to a band selector, the mixer then feeding a filter and decimator.

2. An apparatus to frequency hop an orthogonal frequency division multiplexing access method using digital signal processing technique comprising a 4× oversampled digital to analog converter with reduced resolution attached to a complex up conversion mixer controlled by a digital hopping local oscillator attached to an complex local oscillator signal generator attached to a counter and also attached to a band selector, the mixer then feeding an interpolator.
